(19) United States
(12) Patent Application Publication
(10) Pub. No.: US 2003/0127289 A1
(43) Pub. Date: Jul. 10, 2003

(54) Method for sensorless drive control of an electric vehicle and drive control operating by the method

(76) Inventors: Bernd Peter Elgas, Wunsiedel (DE); Karl-Heinz Lust, Lahnau (DE); Josef Wiesing, Wetzlar (DE); Wolfgang Benzing, Wunsiedel (DE); Manfred Dollinger, Bindlach (DE)

Correspondence Address: LERNER AND GREENBERG, P.A., POST OFFICE BOX 2480, HOLLYWOOD, FL, 33022-2480, US

(21) Appl. No.: 10/347,538

(22) Filed: Jan. 17, 2003

Related U.S. Application Data
(63) Continuation of application No. PCT/EP01/06894, filed on Jun. 19, 2001.

(30) Foreign Application Priority Data
Jul. 17, 2000 (DE) 100 35 069.0
Dec. 23, 2000 (DE) 200 21 901.4

(51) Int. Cl. B66F 9/20

(52) U.S. Cl. 187/224

(57) ABSTRACT

A method for the sensorless drive control of an electric vehicle, especially an industrial truck, driven by a rotating field motor operated by a power converter, the power converter being supplied by an associated constant voltage source, includes calculating actual values of the flow chain of the rotating field motor and at least one other variable dependant on the actual values from a recorded stator voltage and at least n−1 measured phase flows, and regulating the stator flow of the rotating field drive, which is defined by the phase flows, based upon the actual values.

### CROSS-REFERENCE TO RELATED APPLICATION

This application is a continuation of copending International Application No. PCT/EP01/06894, filed Jun. 19, 2001, which designated the United States and was not published in English.

### BACKGROUND OF THE INVENTION

1. Field of the Invention

The invention relates to a method for sensorless drive control of an electric vehicle. It further relates to drive control-operating by the method. An electric vehicle or electromobile is, in this case, understood to mean, in particular, an industrial vehicle also referred to as an industrial truck.

An industrial vehicle operated by an electric motor is normally employed in the area of lifting or conveying loads, it being possible for loads to be lifted and transported indoors and outdoors. For such a purpose, such an industrial vehicle has one or more drive motors and has a lifting device. The normally high number of individual drives, in particular, at least one traction drive, a hydraulic pump drive, and a steering drive, are carried along by the industrial vehicle.

In addition, such an industrial vehicle includes an installed power or DC source, normally in the form of a battery, to be able to carry out the intended task without a supply cable and, therefore, in a mobile fashion.

German Published, Non-Prosecuted Patent Application DE 40 42 041 A1 discloses operating an industrial vehicle with a DC motor of a series configuration without additional sensors for registering rotational speed. However, the drawback with such a series motor is the wear on the commutator and, in particular, the carbon brushes, so that regular maintenance work is required in an undesired manner.

By contrast, brushless rotating field drives, in particular, asynchronous or synchronous motors—with the exception of the bearings—are distinguished by maintenance-free, cost-effective, and rugged engineering. In such a case, as compared with a synchronous machine, comparatively simple regulation or control is possible with an asynchronous machine. In addition, the field weakening that is important for electromobiles or electric vehicles can be employed comparatively effectively. By contrast, the synchronous machine is advantageous with regard to the efficiency in the partial-load range.

With regard to the control method, use is currently predominantly made of U/f characteristic curve control, which assumes steady-state operation of the asynchronous machine. These control methods can also be operated in combination with superimposed speed and/or slip regulation. However, such speed regulation, disclosed by German Patent DE 196 51 281 C2, for example, in particular, when used in an industrial vehicle with a rotating field drive, requires an additional speed sensor or rotary encoder.

These simple control or regulating measures, assuming steady-state operation of the asynchronous machine, therefore, have serious drawbacks when there is no nontransient state and, therefore, a change in the speed or in the torque. In these cases, the asynchronous machine can “stall.” In addition, overcurrents can occur or, at low speeds, the nominal torque is not reached, making it virtually impossible to start up the motor.

A further drawback of these relatively simple control methods or structures is that the machine is not operated with optimum efficiency in the partial-load range. This is critical, in particular, in an industrial vehicle with a limited capacity of the battery that is carried with it because, as such, the time of use per battery charge is shortened drastically. It is, additionally, disadvantageous that, with U/f characteristic curve control, first of all, only the possibility of prescribing the speed is provided. However, in industrial vehicles, a possibility of prescribing the torque is often desirable because, for the driver, the operation of the traction drive is, therefore, equated with the familiar operation of an automobile. In such a case, so to speak, the speed control loop is closed by the driver.

### SUMMARY OF THE INVENTION

It is accordingly an object of the invention to provide a method for sensorless drive control of an electric vehicle and drive control operating by the method that overcome the hereinafore-mentioned disadvantages of the heretofore-known devices of this general type and that, while avoiding the aforementioned drawbacks, provides a particularly suitable method for sensorless drive regulation or control, in particular, of an industrial vehicle, a drive control particularly suitable for carrying out the method, and an industrial vehicle operated with such drive control.

With the foregoing and other objects in view, there is provided, in accordance with the invention, a method for sensorless drive control of an electric vehicle, including the steps of driving the vehicle with a rotating field motor, operated the field motor with an inverter having n phase currents, the inverter being fed with a DC source moved with the inverter and the vehicle, the phase currents determining a stator current of the field motor, determining actual values of a flux linkage of the field motor and also at least one further variable dependent thereon from a registered stator voltage of the field motor and at least n−1 measured phase currents, and setting the stator current utilizing the actual values of the flux linkage and the at least one further variable dependent thereon.

In a vehicle, in particular, an industrial vehicle (which also can be referred to as a hand truck), which is driven by a rotating field motor that, in turn, is operated by an inverter that is fed by a DC source moved with it, sensorless drive control is employed. In such a case, from the registered stator voltage of the rotating field motor and from at least n−1 measured phase currents, actual values of the flux linkage of the rotating field motor and at least one further variable dependent thereon are calculated. By using these values, the stator current of the rotating field drive, which is determined by the phase currents, is set. In such a case, sensorless is understood to mean avoiding the employment or the use of a rotational speed sensor.

Here, the invention is based on the consideration that the aforementioned drawbacks can be avoided if, firstly, a superior method—such as field-oriented control—is employed and if, secondly, when an asynchronous machine is used as a rotating field motor, a suitable flux linkage is calculated and, therefore, without sensors, an actual value of the current rotational speed, of the torque and/or of the rotational angle is provided for the drive control. As a result, when controlling an asynchronous machine with orientation to stator or rotor flux linkage, costly rotational-speed or torque transmitters or sensors that are otherwise necessary, with complicated cabling, are just not required.

In accordance with another mode of the invention, there is provided the step of determining both a torque and a rotational speed of the field motor as actual values.

In accordance with a further mode of the invention, there is provided the step of setting the stator current utilizing a comparison between the actual value of the torque and a nominal value of the torque and a comparison between the actual value of the flux linkage and a nominal value of the flux linkage.

In accordance with an added mode of the invention, there is provided the step of determining the nominal value of the flux linkage from at least one of the rotational speed and nominal values of the stator voltage of the field motor.

In accordance with an additional mode of the invention, there is provided the step of additionally determining the nominal value of the flux linkage utilizing the actual value of the torque.

In accordance with yet another mode of the invention, there is provided the step of determining the actual values of the flux linkage, of the torque, and of the rotational speed with a motor model for the drive control.

In accordance with yet a further mode of the invention, there is provided the step of indirectly determining the stator voltage from a measured voltage of the DC source.

In accordance with yet an added mode of the invention, there is provided the step of registering each of the phase currents with a measuring module operating in accordance with a magnetoresistive effect.

In accordance with yet an additional mode of the invention, there is provided the step of diagnosing faults with at least one of the determined actual values.

With the objects of the invention in view, in an electric vehicle having a DC source moved with the vehicle, an inverter having n phase currents and being fed by the DC source, and a rotating field motor operated by the inverter, the phase currents determining a stator current of the field motor, there is also provided a sensorless drive control including a measuring device determining at least n−1 phase currents of the n phase currents and a voltage value relevant for determining the stator voltage of the field motor, and an arithmetic unit programmed to determine a flux linkage of the field motor and also at least one further variable dependent thereon from the phase currents and from the stator voltage and to calculate, from the at least one further variable and from the flux linkage, at least one of a nominal value of the stator voltage of the field motor and the phase currents for setting the stator current.

In accordance with again another feature of the invention, the arithmetic unit has a motor model of the field motor, the motor model calculating actual values of a torque of the field motor, a rotational speed of the field motor, and the flux linkage of the field motor and a control device determining nominal values of the stator voltage of the field motor from a deviation between the actual value of the flux linkage and the nominal value of the flux linkage.

In accordance with again a further feature of the invention, the arithmetic unit has a control element determining the nominal value of the flux linkage from the actual value of at least one of the rotational speed of the field motor and the nominal values of the stator voltage.

In accordance with again an added feature of the invention, the inverter has a control device connected downstream of the arithmetic unit with respect to a signal flow direction, the control device generating an appropriate control signal for the inverter from the nominal values of the stator voltage.

With the objects of the invention in view, there is also provided an electric industrial vehicle, including a DC source moved with the vehicle, an inverter having n phase currents, the inverter fed by the DC source, a rotating field-motor connected to the inverter and operated by the inverter, the phase currents determining a stator current of the field motor, a sensorless drive control having a measuring device determining at least n−1 phase currents of the n phase currents and a voltage value relevant for determining the stator voltage of the field motor, and an arithmetic unit programmed to determine a flux linkage of the field motor and also at least one further variable dependent thereon from the phase currents and from the stator voltage, and to calculate, from the at least one further variable and from the flux linkage, at least one of a nominal value of the stator voltage of the field motor and the phase currents for setting the stator current.

With the objects of the invention in view, there is also provided a sensorless drive control for an electric vehicle having a DC source moved with the vehicle, an inverter having n phase currents and being fed by the DC source, and a rotating field motor operated by the inverter, the phase currents determining a stator current of the field motor, the drive control including a measuring device determining at least n−1 phase currents of n phase currents of the inverter and a voltage value relevant for determining the stator voltage of the field motor, and an arithmetic unit programmed to determine a flux linkage of the field motor and also at least one further variable dependent thereon from the phase currents and from the stator voltage and to calculate, from the at least one further variable and from the flux linkage, at least one of a nominal value of the stator voltage of the field motor and the phase currents for setting the stator current.

In such a case, by a mathematical algorithm or an arithmetic unit, a determination or estimation of the flux linkage, in particular, of the rotor or stator flux linkage, is expediently carried out. To such an end, use is expediently made of a motor model for the drive control that is configured by using motor characteristic data of the rotating field motor, the model determining the actual value of the flux linkage and, in particular, also the rotational speed and the torque. By using a comparison between the actual value of the torque and a nominal value, and by using a comparison between the actual value of the flux linkage and a nominal value, the nominal value of the respective stator voltage or of the respective phase current is, then, expediently determined. In the process, the nominal value of the flux linkage is advantageously determined by using a control element to which, on the input side, the actual value of the rotational speed and/or the magnitude of the nominal values of the stator voltage are supplied. Alternatively, the nominal value of the flux linkage can, advantageously, be determined by a characteristic curve element from the actual values of the torque and of the rotational speed.

By taking account of the torque, which is supplied as an additional input variable to the control element or the characteristic curve element, in such a case, drive control optimized with respect to efficiency is carried out. Here, the actual value of the torque and/or of the rotational speed is expediently used. If the actual value and the nominal value of the torque or of the rotational speed are at least approximately equal, then the nominal values can also be used for efficiency optimization.

With knowledge of the flux linkages, superior field-oriented control is possible—in a manner analogous to a system having transmitters. In such a case, sensorless regulation is aimed at traction applications or mains-bound drives. The flux linkage can be described mathematically in accordance with the relationship:

$$ψ = {\sum }_{n}^{N} \int \overline{B ⅆ a} .$$

Here, an auxiliary value derived from the basic consideration is concerned, according to which, first of all, as is known, the flux flowing through a surface is defined as a surface integral of the flux density. If the effect on a winding is, then, considered, the number of turns has to be included in order to determine the induced voltage or other variables.

In electric machines, the same flux generally does not flow through all the turns so that the aforementioned auxiliary variable, that is to say, the flux linkage, as it is referred, can be defined in accordance with the aforementioned relationship. Here, the effect of all the turns is combined so that the number of turns no longer enters into the mathematical relationship or representation so implemented. In other words, the flux linkage combines the effect of the magnetic flux on the sum of the turns of a winding by the total effect being described by a conceptual or fictional or virtual flux that flows through precisely one (imaginary) winding with a single turn.

In the method according to the invention, the voltage of the energy store is measured and calculated together with the known pulse duty factor of a pulse inverter to form the stator voltages that, in such a case, are identical to the nominal values of the stator voltages. Alternatively, the stator voltage, that is to say, its actual values, is registered directly. In addition, at least n−1 phase currents are measured in a motor having n phases, n being any desired natural number with n>1. These input variables are combined by calculation, by an arithmetic unit or an algorithm using the motor model, to form the flux linkage. Using such a variable, in turn, the further variables or parameters to be determined, in particular, the torque, the rotational speed, the rotational angle, the rotor, stator, and air-gap flux, or variables proportional thereto in each case, can, then, be determined. The arithmetic unit provides the calculated variables as analog and/or digital variables in the form of appropriate actual values. These variables can also be stored in a memory of a digital arithmetic unit.

So, to regulate the torque—or a variable of the rotating field drive that is proportional thereto—a corresponding variable from the arithmetic unit is used as actual value for the regulation. In an analogous way, to regulate the rotational speed—or a variable proportional thereto—the appropriate variable from the arithmetic unit is used as actual value for the regulation. Likewise, to regulate the rotational angle or a variable proportional thereto, the appropriate variable from the arithmetic unit is used as actual value for the regulation.

At least one of the output variables from the arithmetic unit is, expediently, used for operating data recorders, diagnostic tools, service tools, or life cycle monitoring tools. In addition, one of the output variables from the arithmetic unit is advantageously used to operate the drive unit in an efficiency-optimized manner, by the stator flux linkage, the rotor flux linkage, or the air-gap flux linkage being influenced by using the known variables of rotational speed and torque or torque nominal value or a variable proportional thereto in each case.

In addition, in an industrial vehicle, by using the calculated variables of torque and/or rotational speed—or variables proportional thereto in each case—and by using the possibly known hydraulic and mechanical constants, such as the efficiency, the specific delivery volume of the hydraulic pump, the cylinder area of the lifting cylinder, and/or the transmission ratio of the lifting frame, the lifting load, and/or the travel speed of the load can be determined. These variables can also be used for display, monitoring, or regulating the travel speed.

In addition, during those times in which the hydraulic pump or valves operates decoupled from the hydraulic loads by valves, by using the calculated variables of torque and/or rotational speed—or variables proportional thereto in each case—and by using the possibly known hydraulic and mechanical constants or parameters, in particular, the efficiency or the specific delivery behavior of the hydraulic pump, the viscosity and/or the temperature of the hydraulic oil and/or the temperature of the hydraulic system can, expediently, be determined. These variables also can, in turn, be used for display or monitoring.

The measurement of the currents is expediently carried out by magnetic field gradiometers, the measurement or each measurement being carried out based upon the magnetoresistive effect or of the GMR effect (giant magnetoresistive effect) or of the CMR effect (colossal magnetoresistive effect).

The determination of the stator voltage is, expediently, performed directly by measuring n−1 conductor voltages or n phase voltages in a motor having n phases. The required calculations by or within the algorithm or arithmetic unit are, expediently, carried out by a commonly used microcontroller or signal processor.

The commissioning effort associated with the sensorless drive control can, advantageously, be reduced by self-commissioning. This includes, preferably, automatic identification of the parameters of the rotating field machine and setting an operating point with respect to the predefined flow linkage and tuning of the control loop or of each control loop. Furthermore, in the event of service or during stoppages of the drive, the mechanisms for automatic parameter identification can be used for fault detection and fault diagnosis.

The quality and performance of the sensorless drive control can be increased if the rotating field machine is suitably modified. For example, the lamination section, as it is referred, of the rotor or of the stator can be changed so that clear differences in inductance result, as a function, firstly, of different energization directions and, secondly, of the rotor position. These differences in inductance can, in turn, be determined, it being possible to use the corresponding results to draw conclusions about the current rotor position. In particular, even at low rotational speeds, superior sensorless regulation can be achieved because there is the possibility of connecting up test signals, which, in turn, make reliable identification of the inductances possible.

The advantages achieved with the invention lie, in particular, in the fact that, at the same time as particularly suitable sensorless drive control, relevant state variables or drive parameters, such as, in particular, the motor torque, the motor speed, the rotational angle, the rotor flux, the stator flux, and/or the air-gap flux, which are additionally relevant in an asynchronous motor operated by a pulse inverter or synchronous motor of such an electrically operated vehicle with rotating field drive technology, can be determined and, preferably, also used for diagnostic purposes and for lifetime determinations.

Avoiding the use of sensor components for registering rotational speed and/or torque offers the considerable advantage that reduced ruggedness of the total system on account of the virtually unavoidable endangering of the function of these components, because of the rough conditions of use for such industrial vehicles, can be ruled out. In addition, the efficiency can be improved. Also—apart from the possibility of efficient field weakening—a synchronous machine can be used as a rotating field motor for the drive of an industrial vehicle.

The invention is also particularly suitable in such an electrically operated vehicle, in particular, with regard to the steering lock in an electrically steered vehicle, in which a redundant system with additional rotational speed sensor is required or desired.

Other features that are considered as characteristic for the invention are set forth in the appended claims.

Although the invention is illustrated and described herein as embodied in a method for sensorless drive control of an electric vehicle and drive control operating by the method, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a cross-sectional and partially hidden view of an industrial vehicle having an electric-motor drive and sensorless drive control;

FIG. 2 is a plan and partially hidden view of the industrial vehicle of FIG. 1.

FIG. 3 is a block circuit diagram of functional components of a sensorless drive control according to the invention;

FIG. 4 is a block and schematic circuit diagram of an indirect determination of voltage for the drive control of FIG. 3;

FIG. 5 is a block and schematic circuit diagram of an alternative implementation of the voltage registration of FIG. 4;

FIG. 6 is a block and schematic circuit diagram of a control scheme of the drive control according to the invention; and

FIG. 7 is a torque-speed diagram of a control element according to the invention.

### DESCRIPTION OF THE PREFERRED EMBODIMENTS

In the figures of the drawings, unless stated otherwise, identical reference symbols denote identical parts.

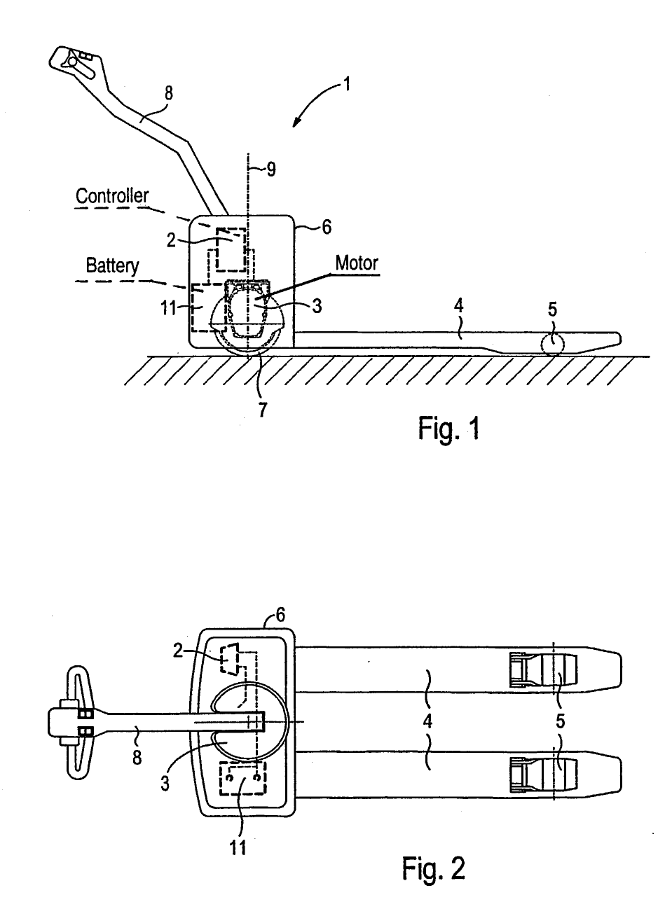

Referring now to the figures of the drawings in detail and first, particularly to FIGS. 1 and 2 thereof, there is shown an industrial vehicle 1 carrying with it a battery 11 as a DC source and a control device 2, designated a drive control below, and an electric-motor drive or drive unit 3 in the form of a brushless rotating field drive, preferably, an asynchronous motor. The battery-operated industrial vehicle 1 includes two forks 4, which are each supported on running rollers 5. As viewed from above, the forks 4 form a U-shaped frame together with a basic console 6. In the area of the basic console 6 there is at least the one electric drive unit 3 with a running wheel 7, which can be pivoted about a vertical axis 9 with the aid of a hand-tiller 8 and serves to steer the industrial vehicle or forklift truck. The drive unit 3 is fed through the drive control 2 from an energy store in the form of a DC source 11, in particular, a battery, for example, a 24 V or a 48 V battery, which is disposed in the basic console 6.

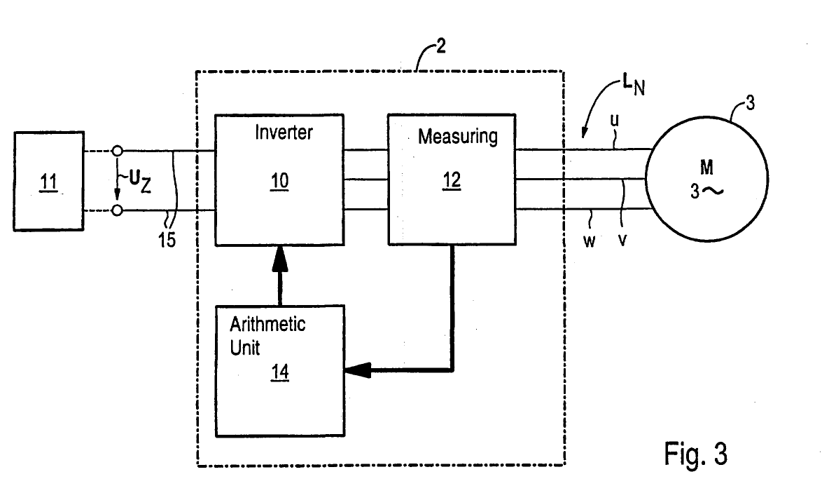

According to FIG. 3, the drive control 2 operating without sensors includes an inverter or pulse inverter 10, a measuring device 12, and an arithmetic unit 14. The direct voltage u_{z} fed to the inverter 10 through feed lines 15 is converted by the inverter 10 into a three-phase alternating voltage that—or the corresponding current—is supplied to the rotating field drive 3 through three phase lines L_{N} (L1,L2,L3 or u,v,w).

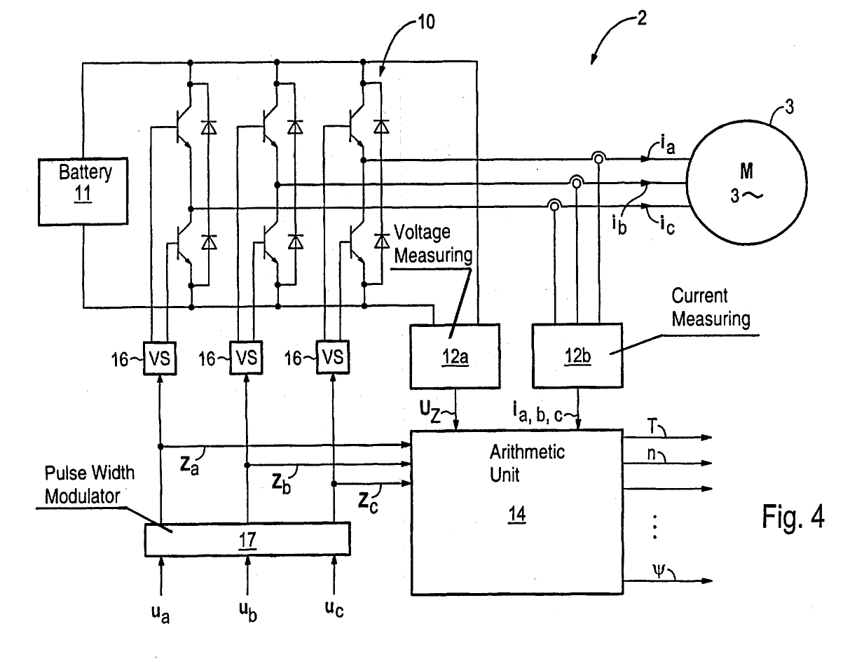

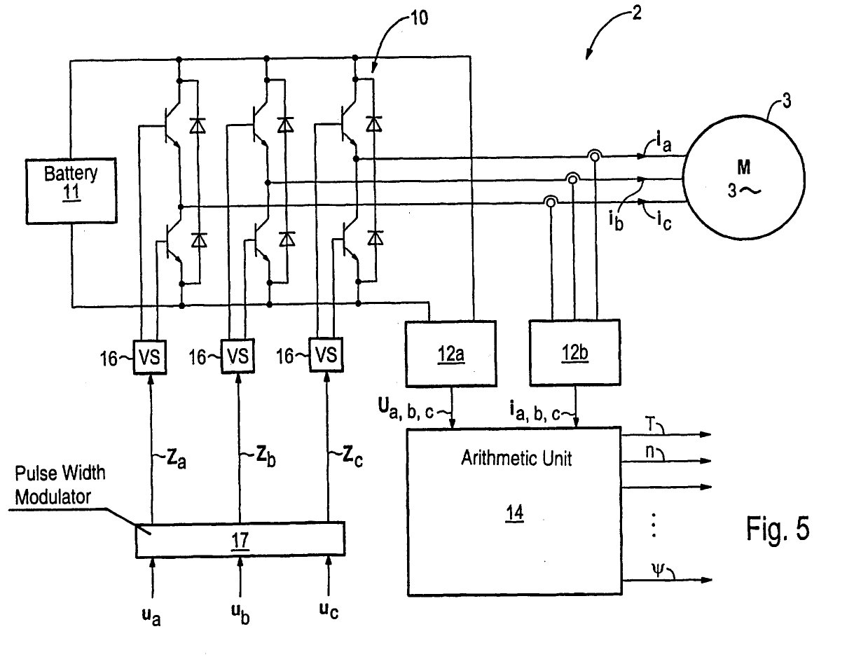

FIGS. 4 and 5 show, in a comparatively detailed manner, the drive control 2 including the pulse inverter 10 and a measuring module 12a for registering voltage and a measuring module 12b for registering current. In such a case, VS designates the respective valve control 16 of the pulse inverter 10. The measuring modules 12a, 12b are connected on the output side to inputs of the arithmetic unit 14.

In the embodiment according to FIG. 4, the voltage u_{z} from the energy store or the battery 11 is measured and is calculated together with the known pulse duty factors of the pulse inverter 10 to form the stator voltages. For such a purpose, nominal pulse duty factors zₐ,z_{b},z_{c} are fed to the input side of the arithmetic unit 14, being generated by a pulse-width modulator 17 associated with the pulse inverter 10 from nominal values of the stator currents i_{a,b,c}. By contrast, in the embodiment according to FIG. 5, the stator voltages u_{a,b,c} are registered directly and supplied to the arithmetic unit 14 through the measuring module 12a.

The state variables or parameters determined by the arithmetic unit 14, in particular, the flux linkage Ψ, the rotational speed n, the torque T, and, for example, also the rotational angle, may be used in very many ways for the drive control 2 of the rotating field motor 3. They permit indirect regulation of the torque T, of the rotational speed n, of the position of the rotor of the rotating field drive 3, or the flux linkage Ψ. The user, therefore, has no restrictions with respect to an interface to the drive 3.

A further important use is the use of the data determined for data loggers or life cycle monitoring. In such a case, for example, overload cases are detected and, in the event of an anticipated failure of the traction drives or of the hydraulic pump, a warning to the user is triggered in good time so that predictive maintenance is carried out. These output variables are, likewise, helpful for diagnostic tools that, in the event of a fault, provide the service engineer with decisive help when looking for faults so that failure times can be shortened.

Furthermore, an important use is the use of the data determined with the aim of efficiency-optimized setting of the operating point of the drive control 2 of the rotating field drive 3 configured, in particular, as an asynchronous machine.

With a known rotational speed n and known torque T and known parameters of the asynchronous machine, the flux linkage Ψ of the latter can be set such that the sum of iron losses and copper losses is a minimum. In the partial-load range, a considerable increase in the efficiency can, therefore, be achieved, which is of great benefit in the case of a battery-operated industrial vehicle 1.

In addition, an important use is the use of the data determined to calculate the lifting load of the industrial vehicle 1, in that, by using variables of torque T and rotational speed n, taking account of the physical laws, in particular, the efficiency of hydraulic pumps and the efficiency of the mechanism and the specific delivery volume of the hydraulic pump, the hydraulic pressure can initially be determined. Taking account of the cylinder area of the lifting cylinder and the transmission ratio of the lifting frame, the lifting load and the travel speed of the lifting frame can be determined. If the hydraulic pump can be uncoupled from the lifting cylinder by valves, the viscosity of the hydraulic oil and, therefore, the temperature of the hydraulic oil or of the hydraulic system can be determined by a similar procedure. The torque T, which the drive 3 has to expend to operate the hydraulic pump at a defined rotational speed n, then depends only on the viscosity of the hydraulic oil.

Furthermore, an important use is the use of the data determined for a redundant system. This is because, if a rotational-speed transmitter or rotary encoder is additionally brought into use, then the corresponding measured variables can be compared with output variables from the arithmetic unit 14. For such a purpose, the output variables from the arithmetic unit 14 are compared with the measured values from a rotary encoder or a rotational speed transmitter or a torque transmitter, the result of the comparison being used for fault detection of sensors used or of the drive 3. In the event of a defect occurring in a sensor, the drive regulation or control 2 can, then, be continued with the corresponding output variable T, n, Ψ from the arithmetic unit 14 so that an advantageous, redundant system is produced. In the event of noticeable deviations, there is a fault in the drive system or in the transmitters, and the drive 3 can be switched off or operated in a type of emergency operation without the sensors, until the fault can be rectified at the next service or maintenance time.

Due to the fact that, because of the small battery voltages used, it is necessary to operate with very high currents i_{a,b,c}, the measuring module 12b required for this application, as opposed to the U/f characteristic curve control, for measuring the currents i_{a,b,c} is configured as a magnetic field gradiometer based on the magnetoresistive (MR) effect, the giant magnetoresistive (GMR) effect, or the colossal magnetoresistive (CMR) effect. These magnetic field gradiometers permit the currents i_{a,b,c} to be measured in the smallest possible space, because a measurement without a magnetic flux concentrator is possible, because of the high sensitivity.

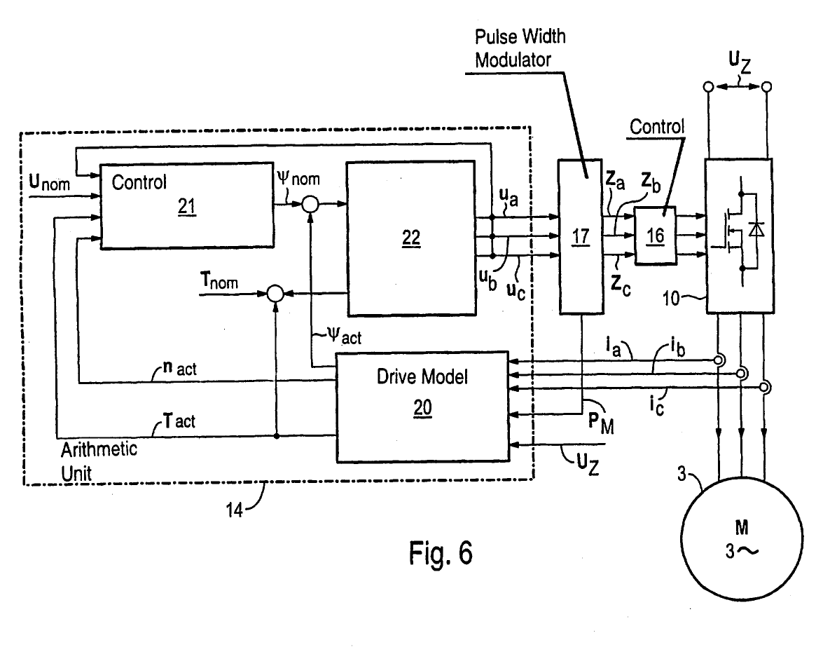

FIG. 6 shows the control scheme of the sensorless drive control 2, again with the rotating field drive 3 and the inverter 10 operating the latter and also with the arithmetic unit 14. The arithmetic unit 14 includes a motor or drive model 20 that simulates the rotating field drive 3 and to which the registered phase currents i_{a,b,c} and the measured values u_{z} of the DC or intermediate circuit voltage supplied by the DC source 11 are supplied on the input side. In addition, the motor model 20 is supplied with the pulse width ratio or the level of modulation P_{M} of the pulse-width modulator 17. From these input values i_{a,b,c,} P_{M}, and u_{z}, the motor model 20 determines the actual value of the flux linkage Ψ_{act} and the actual value of the torque T_{act} and the actual value of the rotational speed n_{act}.

For such a purpose, in the motor model 20, which is configured by using motor-specific variables, use is made of the variables proportional to the phase currents i_{a,b,c} in accordance with the relationships:

$$\begin{matrix}{T}_{el} = \frac{3}{2} p \cdot \frac{{L}_{h}}{{L}_{R}} \cdot {ψ}_{Rd} \cdot {i}_{Sq} \\ {ψ}_{Rd} + \frac{{L}_{R}}{{R}_{R}} \cdot {ψ}_{Rd} = {L}_{h} \cdot {i}_{Sd}\end{matrix}$$

in rotor flux coordinates, and the relationships:

$$\begin{matrix}{T}_{el} = \frac{3}{2} p \cdot {ψ}_{Sd} \cdot {i}_{Sq} \\ {ψ}_{Sd} = {L}_{S} \cdot {i}_{Sd} - {ω}_{FR} \cdot \frac{{L}_{R}}{{R}_{R}} \cdot σ \cdot {L}_{S} \cdot {i}_{Sq}\end{matrix}$$

in stator flux coordinates. Here, Tₑ₁ is the internal torque of the rotating field drive 3, p the number of pole pairs, Lₕ the main inductance, L_{R} the rotor inductance based on the stator side of the rotating field drive 3, Ψ_{Rd} is the flux linkage, with Ψ_{Rd} proportional to the voltage measured value u_{z}, R_{R} is the rotor resistance based on the stator side, and σ is the scattering factor. The index R always stands for rotor variables, while the index S stands for stator variables. The index d designates the real part and the index q designates the imaginary part of a space vector in flux coordinates.

In addition, ω_{FR} is the angular velocity of the flux linkage Ψ in the rotor-based coordinate system. The angular velocity of the flux linkage Ψ in the stator-based coordinate system is given by the relationship:

$${ω}_{FS} = \frac{{u}_{Sq} - {R}_{S} \cdot {i}_{Sq}}{{ψ}_{S}} ,$$

where u_{Sq} is the stator voltage.

The stator flux linkage is given by the relationship:

$${ψ}_{S} = \int {u}_{S} - k - {R}_{S} \cdot {i}_{S} \cdot ⅆ t .$$

The actual rotational speed or the actual value n_{act} of the rotational speed n is determined from this in accordance with the relationship 2π·p·n_{act}=ω_{Rs}=ω_{FS}−ω_{FR}, in which:

$${ω}_{FR} = \frac{σ \cdot {L}_{S} \cdot ⅆ {i}_{Sq} / ⅆ t + {R}_{R} \cdot {i}_{sq}}{{ψ}_{Sd} - σ \cdot {L}_{S} \cdot {i}_{Sd}}$$

takes account of the angular velocity of the flux linkage Ψ in the stator-based coordinate system and the slip, and ω_{RS} is the angular velocity of the rotor of the rotating field drive 3.

From the actual value of the rotational speed n_{act}, the nominal value Ψₙₒₘ of the flux linkage is determined by a control element 21. In such a case, optimum torque formation is ensured by the flux-forming and the torque-forming components of the current space vector being predefined suitably such that, firstly, the maximum permissible length of the current space vector and, secondly, the maximum space vector length of the stator voltage u_{S} that can be set by the inverter 17 is not exceeded. Here, the control element 21 can be implemented as a characteristic curve element or as a voltage controller for setting the flux, that is to say, for determining the nominal value Ψₙₒₘ.

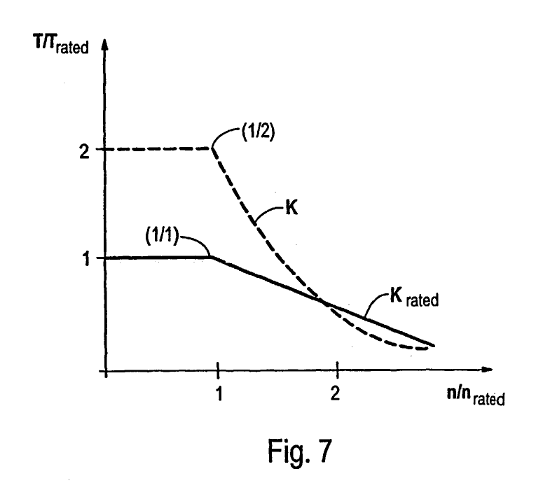

In the case in which a characteristic curve element is used as the control element 21, the actual values n_{act} and T_{act} of the rotational speed n and of the torque T are fed to the input of the control element 21. In the torque-speed diagram in FIG. 7, the speed n is plotted on the abscissa and the torque T is plotted on the ordinate, in each case, based on the rated speed n_{rated} and the rated torque T_{rated}. Shown dashed is the characteristic curve K that is given by motor-specific characteristic data and, beginning from the pair of values (1/2), runs with the function K≈1/n² as the envelope of the stalling torques for various synchronous or rated rotational speeds, while the rated characteristic curve K_{rated} runs with the function K_{rated}≈1/n starting from the pair of values (1/1). On the output side, the control or characteristic curve element 21 supplies the nominal value Ψₙₒₘ of the flux linkage Ψ as a function of the torque T and—through the proportionality between the rotational speed n and the q component of the stator current i_{Sq}—of the rotational speed n.

As a result of the requirement for the maximum torque T, the nominal value Ψₙₒₘ of the flux linkage Ψ is determined unambiguously as a function of the rotational speed n at a predetermined intermediate circuit voltage u_{z}. In the partial-load range of the vehicle 1, an additional degree of freedom is produced, which can be used to optimize the efficiency of the drive or motor 3. The control element 21, then, additionally needs the actual value T_{act} or the nominal value Tₙₒₘ of the torque T for such a purpose.

If the control element 21 is implemented as a characteristic curve element, then, in this case, a two-dimensional characteristic map or characteristic curve element is produced, with the rotational speed n and the torque T as input variables. The output variable from the control element 21 is also in this case the nominal value Ψₙₒₘ of the flux linkage Ψ. Therefore, by using the control element 21, it is possible to move specifically to an operating point of the rotating field drive 3. The improvement in the efficiency is carried out by an optimization calculation using a model of the rotating field machine 3 that describes the copper and iron losses.

The maximum torque T and the load cycle are critical for the construction of the rotating field motor 3. Because the acceleration of the vehicle 1, which is carried out at maximum torque T, is generally already completed after a short time, the rotating field motor 3 can be configured for the maximum stator current i_{S} that can be provided by the inverter 10. The maximum speed of the vehicle 1 is kept in a range in which the stalling torque lies below the rated torque and is, therefore, decisive.

The result of the comparison between the nominal value Ψₙₒₘ of the flux linkage so determined and the actual value Ψ_{act} of the flux linkage determined by the motor model 20, on one hand, and the result of the actual value T_{act} of the torque likewise determined by the motor model 20 with a predefinable nominal value Tₙₒₘ of the torque are fed to the input side of a control device 22 of the arithmetic unit 14. By using the control deviations of flux linkage Ψ and torque T, forming the input variables, the control device 22 determines the nominal value u_{a,b,c} of the stator voltage us. Because the flux linkage Ψ is proportional to the component of the stator current i_{Sd}, a controlled deviation for the d current component i_{Sd} can be determined directly from the control deviation of the flux linkage Ψ.

Alternatively, flux regulation can also be carried out, and regulation of the corresponding current component in a subordinate current control loop can be effected. The relationships in the torque-forming branch are similar. Because the electric torque Tₑ₁ is proportional to the q stator current component i_{Sd}, a control deviation for the q stator current component i_{Sd} can be determined directly with the torque control deviation. Alternatively, however, torque regulation can, again, initially be carried out here as well, while the control of the q current component i_{Sd} is performed in a subordinate current control loop.

The input variables to the control device 22 are present in a field-oriented coordinate system. The output variables u_{a,b,c} from the control device 22 are present in stator-based coordinates. The corresponding coordinates transformation is, therefore, performed within the control device 22. In such a case, it is unimportant at which point this transformation is carried out. For example, the regulation of the two stator current components can be carried out in the field-oriented coordinate system. In such a case, the output variables from the current regulators, namely the nominal voltage values u_{Sd} and u_{Sq}, are transformed into the stator-based variables u_{a,b,c}.

Alternatively, the nominal current values i_{Sd} and i_{Sq} can be transformed into the stator-based variables i_{a,b,c}, and the current regulation can be carried out in the stator-based coordinate system. In such a case, the nominal voltage values u_{a,b,c} are present directly in stator-based coordinates. The coordinate system in which the current regulation is carried out can, therefore, be chosen freely. However, the output variables from the control device 22 are always the nominal voltage values u_{a,b,c} and the stator voltage us in stator-based coordinates.

Through the pulse-width modulator 17 and the valve control or control device 16, these nominal voltage values uₐ, u_{b}, u_{c} are passed on as switching commands to the pulse inverter 10. The pulse inverter 10 represents the actuating element with which the desired voltage u_{S} is applied to the rotating field drive or motor 3. Depending on the electric parameters of the motor or drive 3 and on the mechanical rotational speed n, a stator current i_{S} is established in the windings of the motor 3, is measured through the measuring module 12b by using the actual values of the phase currents i_{a,b,c}, and is supplied to the motor model 20 of the rotating field machine 3.

If the control element 21 is configured as a voltage regulator, then such voltage regulation permits simple predefinition of the flux linkage Ψₙₒₘ in the field weakening range. The controlled variable is the voltage demand of the rotating field motor 3. Accordingly, the actual value u_{act} supplied to the voltage regulator 21 results from the magnitude of the space vector of the stator voltage u_{S}, which is predefined by the current regulation. Alternatively, the stator voltage magnitude can also be determined by direct measurement. The nominal value uₙₒₘ of the voltage regulation is derived from the intermediate circuit voltage u_{z} and represents the maximum magnitude of the stator voltage u_{S} that can be provided by the pulse inverter 17. In addition, a small reserve provision can also be kept in reserve.

The mechanism of action of the voltage regulation in the control element 21 is as set forth in the following text.

The voltage demand of the rotating field drive 3 can be influenced decisively by the flux linkage Ψ. If, then, the voltage demand of the drive 3 is greater than the nominal value uₙₒₘ from the voltage regulation 21, the actuating variable of the voltage control loop, that is to say, the nominal value Ψₙₒₘ of the flux linkage, is reduced. As a result, after the transient processes have decayed, the voltage demand of the drive 3 also decreases. If, conversely, the voltage demand is less than the nominal value uₙₒₘ from the voltage regulation, then the nominal value Ψₙₒₘ of the flux linkage is increased. In the steady-state case, the drive 3, therefore, always operates in the field weakening range with the maximum stator voltage u_{S} that can be provided, and the setting of the flux linkage Ψ is carried out automatically.

The drive control 2 can advantageously also be employed in a golf cart or the like.

We claim:

1. A method for sensorless drive control of an electric vehicle, which comprises:
driving the vehicle with a rotating field motor;
operated the field motor with an inverter having n phase currents, the inverter being fed with a DC source moved with the inverter and the vehicle, the phase currents determining a stator current of the field motor;
determining actual values of a flux linkage of the field motor and also at least one further variable dependent thereon from:
a registered stator voltage of the field motor; and
at least n−1 measured phase currents; and
setting the stator current utilizing the actual values of the flux linkage and the at least one further variable dependent thereon.

2. The method according to claim 1, which further comprises determining both a torque and a rotational speed of the field motor as actual values.

3. The method according to claim 1, wherein the at least one further variable is a torque and a rotational speed of the field motor and which further comprises determining both the torque and the rotational speed as actual values.

4. The method according to claim 2, which further comprises setting the stator current utilizing:
a comparison between the actual value of the torque and a nominal value of the torque; and
a comparison between the actual value of the flux linkage and a nominal value of the flux linkage.

5. The method according to claim 4, which further comprises determining the nominal value of the flux linkage from at least one of the rotational speed and nominal values of the stator voltage of the field motor.

6. The method according to claim 5, which further comprises additionally determining the nominal value of the flux linkage utilizing the actual value of the torque.

7. The method according to claim 2, which further comprises determining the actual values of the flux linkage, of the torque, and of the rotational speed with a motor model for the drive control.

8. The method according to claim 1, which further comprises indirectly determining the stator voltage from a measured voltage of the DC source.

9. The method according to claim 1, which further comprises registering each of the phase currents with a measuring module operating in accordance with a magnetoresistive effect.

10. The method according to claim 1, which further comprises registering each of the phase currents with a magnetoresistive effect measuring module.

11. The method according to claim 1, which further comprises diagnosing faults with at least one of the determined actual values.

12. The method according to claim 1, wherein the electric vehicle is an industrial vehicle.

13. In an electric vehicle having a DC source moved with the vehicle, an inverter having n phase currents and being fed by the DC source, and a rotating field motor operated by the inverter, the phase currents determining a stator current of the field motor, a sensorless drive control comprising:
a measuring device determining:
at least n−1 phase currents of the n phase currents; and
a voltage value relevant for determining the stator voltage of the field motor; and
an arithmetic unit programmed:
to determine a flux linkage of the field motor and also at least one further variable dependent thereon from the phase currents and from the stator voltage; and
to calculate, from said at least one further variable and from said flux linkage, at least one of:
a nominal value of the stator voltage of the field motor; and
the phase currents for setting the stator current.

14. The sensorless drive control according to claim 13, wherein said arithmetic unit has:
a motor model of the field motor, said motor model calculating actual values of a torque of the field motor, a rotational speed of the field motor, and said flux linkage of the field motor; and
a control device determining nominal values of the stator voltage of the field motor from a deviation between said actual value of said flux linkage and said nominal value of said flux linkage.

15. The sensorless drive control according to claim 14, wherein said arithmetic unit has a control element determining said nominal value of said flux linkage from said actual value of at least one of said rotational speed of the field motor and said nominal values of the stator voltage.

16. The sensorless drive control according to claim 13, wherein said inverter has a control device connected downstream of said arithmetic unit with respect to a signal flow direction, said control device generating an appropriate control signal for the inverter from said nominal values of the stator voltage.

17. An electric industrial vehicle, comprising:
a DC source moved with the vehicle;
an inverter having n phase currents, said inverter fed by said DC source;
a rotating field motor connected to said inverter and operated by said inverter, said phase currents determining a stator current of said field motor;
a sensorless drive control having:
a measuring device determining:
at least n−1 phase currents of said n phase currents; and
a voltage value relevant for determining said stator voltage of said field motor; and
an arithmetic unit programmed:
to determine a flux linkage of said field motor and also at least one further variable dependent thereon from said phase currents and from said stator voltage; and
to calculate, from said at least one further variable and from said flux linkage, at least one of:
a nominal value of said stator voltage of said field motor; and
said phase currents for setting said stator current.

18. The sensorless drive control according to claim 17, wherein said arithmetic unit has:
a motor model of said field motor, said motor model calculating actual values of a torque of said field motor, a rotational speed of said field motor, and said flux linkage of said field motor; and
a control device determining nominal values of said stator voltage of said field motor from a deviation between said actual value of said flux linkage and said nominal value of said flux linkage.

19. The sensorless drive control according to claim 18, wherein said arithmetic unit has a control element determining said nominal value of said flux linkage from said actual value of at least one of said rotational speed of said field motor and said nominal values of said stator voltage.

20. The sensorless drive control according to claim 17, wherein said inverter has a control device connected downstream of said arithmetic unit with respect to a signal flow direction, said control device generating an appropriate control signal for said inverter from said nominal values of said stator voltage.

21. A sensorless drive control for an electric vehicle having a DC source moved with the vehicle, an inverter having n phase currents and being fed by the DC source, and a rotating field motor operated by the inverter, the phase currents determining a stator current of the field motor, the drive control comprising:
a measuring device determining:
at least n−1 phase currents of n phase currents of the inverter; and
a voltage value relevant for determining the stator voltage of the field motor; and
an arithmetic unit programmed:
to determine a flux linkage of the field motor and also at least one further variable dependent thereon from the phase currents and from the stator voltage; and
to calculate, from said at least one further variable and from said flux linkage, at least one of:
a nominal value of the stator voltage of the field motor; and
the phase currents for setting the stator current.
